(19) United States
(12) Patent Application Publication
(10) Pub. No.: US 2021/0298353 A1
(43) Pub. Date: Sep. 30, 2021

(54) SMOKING DEVICE WITH HEAT ACTIVATED VENTS

(71) Applicant: Hadek C. F. Ltd., Haifa (IL)

(72) Inventors: Dmitry VOLOVICH, Haifa (IL); Itamar PRESESS, Haifa (IL)

(73) Assignee: Hadek C. F. Ltd., Haifa (IL)

(21) Appl. No.: 16/833,820

(22) Filed: Mar. 30, 2020

(51) Int. Cl. A24F 1/32; F03G 7/06; A24F 7/04; A24F 1/28

(52) U.S. Cl. CPC A24F 1/32; A24F 1/28; A24F 7/04; F03G 7/065

(57) ABSTRACT

Systems and methods for a smoking device for smoking a substance, the smoking device including: a hollow body, configured to hold the substance, wherein the hollow body includes: a tube defining a combustion bore within having vents, each of the vents being covered by a flap of a plurality of flaps having an initial shape configured to cover that vent, wherein when a combustion front of substance recedes into the combustion bore, any flap of the flaps that is heated to a threshold temperature bends away uncovering the vent it covers, and, when cooled, that flap regains its initial shape so as to cover that vent.

### FIELD OF THE INVENTION

The present invention relates to smoking devices. More particularly, the present invention relates to a smoking device with one or more heat activated vents.

### BACKGROUND OF THE INVENTION

Smoking is a widespread practice in which a substance is burned and the resulting smoke is inhaled, some of which smoke is absorbed in the bloodstream. A variety of smoking devices can be used for smoking tobacco, medical marijuana or other substances, which attempt to replace rolled cigarettes. However, the user experience when smoking with these devices is usually very different from the experience of smoking rolled cigarettes as a result of differences in the tobacco combustion rate.

For example, some existing devices use a glass tube to replace the paper cigarette, but the combustion rate within the glass tube is different than the combustion rate in rolled cigarettes. Despite the advantage of multiple refills of the device with tobacco, the user experience is very different, and there is still a need for a replacement for rolled cigarettes.

### SUMMARY OF THE INVENTION

There is thus provided, in accordance with some embodiments of the invention, a smoking device for smoking a substance, the smoking including a hollow body, configured to hold the substance, wherein the hollow body includes a tube defining a combustion bore within having vents, each of the vents being covered by a flap of a plurality of flaps having an initial shape configured to cover that vent. In some embodiments, when a combustion front of substance recedes into the combustion bore, any flap of the flaps that is heated to a threshold temperature bends away, uncovering the vent it covers, and, when cooled, that flap regains its initial shape so as to cover that vent.

In some embodiments, each flap may be connected to the hollow body by a fixture. In some embodiments, the hollow body may have a tubular shape. In some embodiments, the flap may include a heat activated shape memory alloy. In some embodiments, the flap may include Nitinol. In some embodiments, the flap may include a heat activated material. In some embodiments, the flap may include a bimetal.

In some embodiments, area of each of the one or more vents may be larger than the cross-section area of the combustion bore. In some embodiments, the smoking device may include an inhaling bore, configured to allow inhaling of smoke of the substance when burning. In some embodiments, the smoking device may include a filter adjacent to the inhaling bore. In some embodiments, the hollow body may include low-thermal-expansion glass. In some embodiments, the glass may include a glass portion that is at least partially transparent.

In some embodiments, the threshold temperature may be in the range of 100-900° C. degrees. In some embodiments, a shape of at least one vent may be a perforated line. In some embodiments, a shape of at least one vent may be at least one of a rectangle and an ellipse. In some embodiments, a shape of at least one flap may be at least one of a rectangle and an ellipse.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a lateral view of a smoking device with an open vent, according to some embodiments of the invention;

FIG. 1B schematically illustrates a lateral view of a smoking device with two open vents, according to some embodiments of the invention;

FIG. 2 schematically illustrates a side view of the smoking device, according to some embodiments of the invention;

FIG. 3A schematically illustrates an example of a smoking device with a first shape of flaps, according to some embodiments of the invention;

FIG. 3B schematically illustrates an example of a smoking device with a second shape of flaps, according to some embodiments of the invention;

FIG. 3C schematically illustrates an example of a smoking device with a third shape of flaps, according to some embodiments of the invention;

FIG. 3D schematically illustrates an example of a smoking device with a fourth shape of flaps, according to some embodiments of the invention;

FIG. 3E schematically illustrates an example of a smoking device with a fifth shape of flaps, according to some embodiments of the invention;

FIG. 3F schematically illustrates an example of a smoking device with a sixth shape of flaps, according to some embodiments of the invention;

FIG. 3G schematically illustrates a cone shaped smoking device, according to some embodiments of the invention; and

FIG. 4 schematically illustrates another smoking device, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

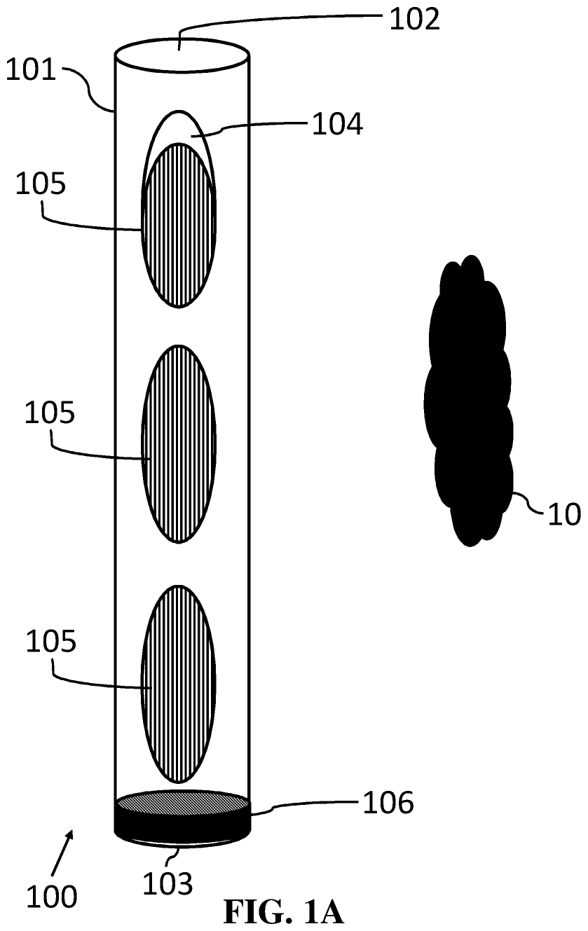

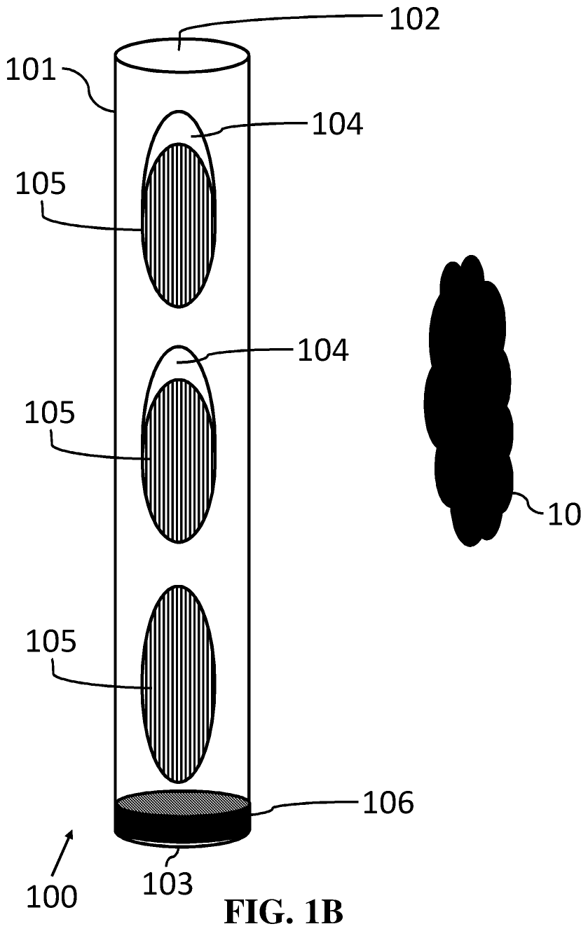

Reference is now made to FIGS. 1A-1B, which schematically illustrate a lateral view of a smoking device 100 with open and closed vents, according to some embodiments. The smoking device 100 may be a multiuse device configured to allow smoking of a substance 10 (e.g., tobacco or medical marijuana) with the same device 100 repeatedly. For example, the smoking device 100 may allow smoking of the substance 10 with the same device 100. In some embodiments, the smoking device 100 may be configured to allow smoking the substance 10 in a similar way (or similar user experience) to smoking with a rolled cigarette.

The smoking device 100 may include a hollow body 101, for example in the form of a tube. The hollow body 101 may be configured to hold the substance 10. In some embodiments, the smoking device 100 may be a multiuse device, such that, once the substance 10 has been fully consumed, the smoking device 100 may be refilled with smoking substance and reused.

For example, the hollow body 101 may have a tubular shape, similarly to the shape of a cigarette. In some embodiments, the hollow body 101 may have dimensions that are configured to allow a user to hold the smoking device 100 by the hand. In another example, the hollow body 101 may include a low-thermal-expansion glass portion, for instance the glass portion being at least partially transparent.

In some embodiments, the hollow body 101 may include a tube defining a combustion bore 102. The combustion bore 102 may be configured to allow combustion when the substance 10 is lit, for example by lighting the substance 10 with a lighter. In some embodiments, the hollow body 101 may further include an inhaling bore 103. The inhaling bore 103 may be configured to allow inhaling of smoke from the substance 10, similar to lighting tobacco and inhaling smoke in a rolled cigarette.

In some embodiments, the combustion bore 102 and the inhaling bore 103 may have different dimensions. For example, the hollow body 101 may have a cone-like structure such that one of the combustion bore 102 and the inhaling bore 103 may be larger than the other.

According to some embodiments, the hollow body 101 may include one or more vents 104. The one or more vents 104 may be configured to allow air access into the hollow body 101. In some embodiments, with additional vents 104 to allow air access into the hollow body 101, the combustion rate of the substance 10 within the hollow body 101 may be changed, since the combustion rate may depend on the supply of air therein.

In some embodiments, each of the one or more vents 104 may be larger (e.g., having a larger area) than the combustion bore 102.

In some embodiments, each vent 104 may be covered by a flap 105 of a plurality of flaps, generally having an initial shape configured to cover that vent 104. The flap 105 may be configured to move such that the vent 104 is open, for instance as shown in FIG. 1A, in order to allow air access into the hollow body 101 via the corresponding vent 104. In some embodiments, the flap 105 may include a temperature dependent material that changes its shape (e.g., bends) with change in temperature (e.g., when the material is heated).

When a combustion front of the substance 10 recedes into the combustion bore 102, any flap 105 of the flaps 105 that is heated to a threshold temperature may bend away, thereby uncovering the vent 104 that it covers. In some embodiments, when cooled, that flap 105 may regain its initial shape so as to cover that vent 104. For example, the smoking device 100 as shown in FIG. 1A has a single vent 104 open due to bending of the corresponding heated cover 105. As the combustion front of the substance 10 recedes into the combustion bore 102, another cover 105 may be bent, and thus another vent 104 may be open, as shown in FIG. 1B. Thus, all remaining vents 104 may be similarly opened as the combustion front recedes.

In some embodiments, when the vent 104 is closed, for instance as shown in FIG. 1B, the flap 105 may be covering the vent 104.

For example, the flap 105 may include a heat activated shape memory alloy (e.g., with Nitinol. In another example, the flap 105 may include a heat activated bimetal.

In some embodiments, the flap 105 may be configured to bend or curve when the flap 105 is heated to a predetermined or threshold temperature. The predetermined temperature may correspond to the temperature required to move the flap 105 to open the vent 104, for instance as shown in FIG. 1A. The flap 105 may accordingly move to close the vent 104, for instance as shown in FIG. 1B, when the temperature drops from the predetermined temperature. In some embodiments, the predetermined temperature may correspond to the type of the substance 10. In some embodiments, the threshold temperature may be in the range of 100−900° C. degrees. The heat-activated material may be calibrated to a threshold temperature related to specific substance 10. For example, for tobacco, the range may be from about 400° C. between puffs to about 900° C. during a puff.

According to some embodiments, the smoking device 100 may include a filter 106 adjacent to the inhaling bore 103. For example, the filter 106 may be positioned between the inhaling bore 103 and a vent 104 nearest to the inhaling bore 103. During smoking, smoke inhaled by the user from the hollow body 101, via the inhaling bore 103, may initially pass through the filter 106. In some embodiments, the filter 106 may be changed by the user.

In some embodiments, smoking the substance 10 using the smoking device 100 may cause a combustion rate that is similar to the combustion rate achieved when smoking a rolled cigarette. Thus, the user experience of smoking using the smoking device 100 may be similar to the user experience of smoking a rolled cigarette, when smoking the same type of substance 10.

The combustion rate of the smoking device 100 may be determined based on at least one of: the amount of the substance 10 in the smoking device 100, the dimensions of the smoking device 100, and/or the rate of air access into the hollow body 101. In some embodiments, the dimensions of the smoking device 100 and/or the predetermined temperature to move the flap 105 may be selected to create a combustion rate similar or close to that achieved when smoking a rolled cigarette. In some embodiments, the combustion rate of the substance 10 in the smoking device 100 may be substantially the average combustion rate of the substance 10 used in a rolled cigarette.

In some embodiments, the dimensions of the smoking device 100 may be configured to hold the same amount of substance 10 that is substantially the average amount of the substance with a rolled cigarette, such that there is no need to change the used amount of substance 10 within the smoking device 100 in order to achieve the user experience of smoking a rolled cigarette.

According to some embodiments, the smoking device 100 may be initially with closed vents 104, for instance as shown in FIG. 1B, with each flap 105 fully covering the corresponding vent 104. When the substance 10 within the hollow body 101 is lit, the heat from the combustion of the substance 10 may cause an increase of temperature at the hollow body 101. In some embodiments, increase of temperature may accordingly cause the heat activated flap 105 to move to open the vent 104, for instance as shown in FIG. 1A, in order to allow air access into the hollow body 101.

In some embodiments, the one or more vents 104 in the hollow body 101 may allow the user to access the inner portion of the hollow body 101, where the substance 10 may be held. After the user finishes smoking the substance 10 using the smoking device 100, the leftovers of the substance 10 (remaining after smoking) may be removed and/or cleaned through the one or more vents 104. Thus, the smoking device 100 may be easily cleaned between uses.

In some embodiments, the smoking device 100 may be cleaned with running water through the hollow body 101, for example to remove leftovers of the substance 10 remaining after smoking. With application of cold water by the user, the temperature of the flaps 105 may accordingly drop. When the temperature is lowered, the flap 105 for each of the one or more vents 104 may return to the initial closed state (returning to the original shape) such that the one or more vents 104 are closed, for instance as shown in FIG. 1B, such that the smoking device 100 may be reused for refilling and smoking new substance 10.

In some embodiments, the smoking device 100 may be configured to allow re-lighting (e.g., with a lighter) of the substance 10 within the hollow body 101, during smoking of the substance 10. For example, the user may initially light the substance 10 within the hollow body 101 and then use the smoking device 100 for smoking the substance 10. During smoking, the user may re-light the substance 10 within the hollow body 101, as may be required for instance when smoking medical marijuana. In some embodiments, in order to re-light the substance 10 within the hollow body 101, the user may heat a closed flap 105 covering a vent 104 until the shape of the heated flap 105 changes to bend and the vent 104 is opened (e.g., to allow direct lighting of the substance 10). In some embodiments, the one or more vents 104 that provide air access into the hollow body 101, may also allow the re-lighting of the substance 10 due to the supply of air. Thus, the smoking device 100 may allow smoking and re-lighting of the substance 10, with the user experience similar to the user experience of smoking a rolled cigarette.

According to some embodiments, the one or more vents 104 may be dispersed along the hollow body 101 in various configurations. For example, at least one vent 104 may be adjacent to the combustion bore 102 and/or to the inhaling bore 103. In another example, one or more vents 104 may be unevenly dispersed along the hollow body 101 (e.g., with one vent 104 adjacent to the combustion bore 102 and other vents 104 adjacent to the inhaling bore 103). In some embodiments, the distribution of the one or more vents 104 along the hollow body 101 may influence air access into the hollow body 101 and, accordingly, influence the combustion rate within.

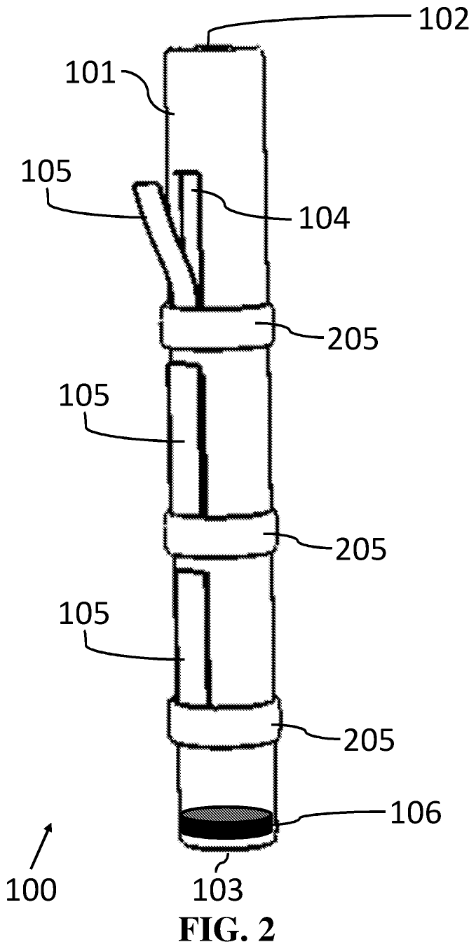

Reference is now made to FIG. 2, which schematically illustrates a side view of the smoking device 100, according to some embodiments. The smoking device 100 may include at least one fixture 205 for coupling each flap 105 to the hollow body 101. Thus, each flap 105 may be connected to the hollow body 101 by a fixture 205. In some embodiments, the at least one fixture 205 may not be temperature dependent in order to maintain coupling of the flap 105 to the hollow body 101 even when the temperature increases. For example, at least one fixture 205 may be ring shaped.

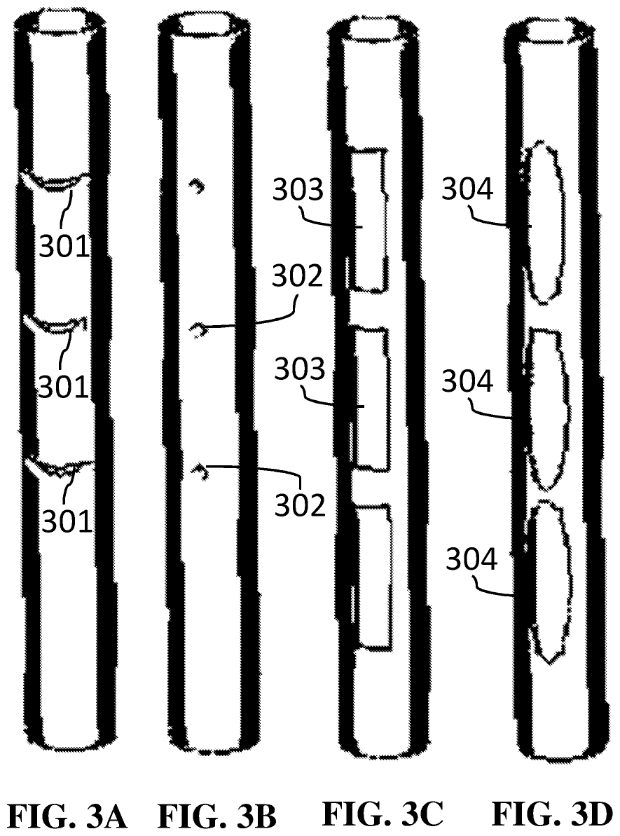

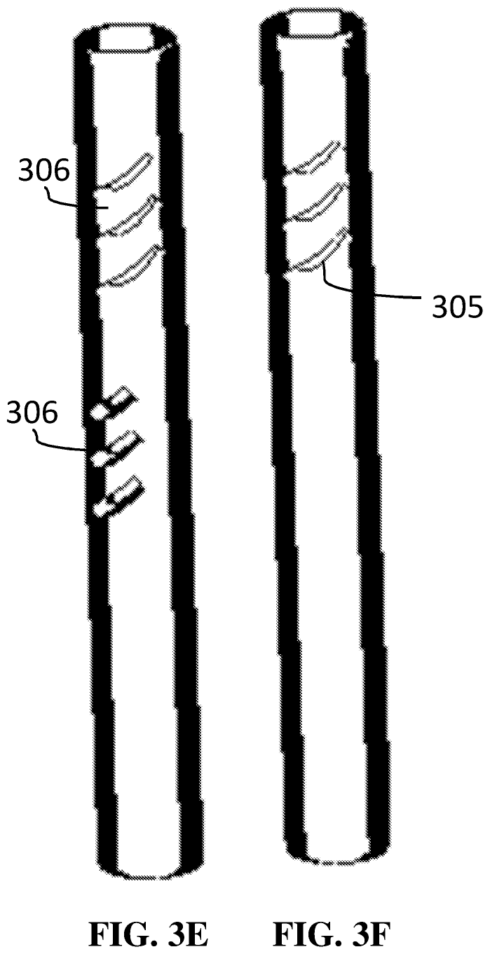

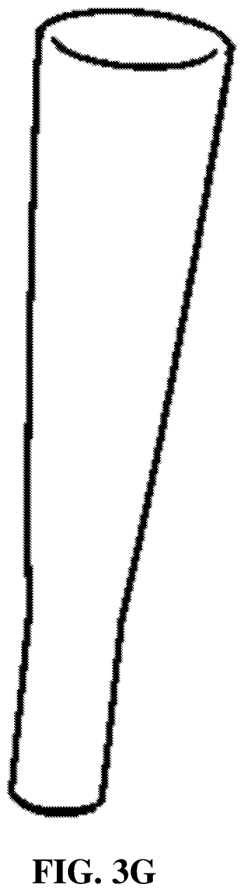

Reference is now made to FIGS. 3A-3F, which schematically illustrate several examples of smoking devices with different shapes of the one or more vent 104 and/or the flaps 105, according to some embodiments. The shape of the one or more vent 104 and/or the shape of the corresponding flap 105 may be at least one of: a hole with various diameters 301 (e.g., as shown in FIG. 3A), a perforated line with different lengths 302 (e.g., as shown in FIG. 3B), a rectangular with different lengths and/or widths 303 (e.g., as shown in FIG. 3C), and/or an ellipse 304 (e.g., as shown in FIG. 3D).

In some embodiments, the shape of the one or more vent 104 and/or the shape of the corresponding flap 105 may be at least one of: a series of perforated line vent with various number of lines and/or slope angles 305 (e.g., as shown in FIG. 3E), and/or a pattern of perforated line vent series with different shifts 306 (e.g., as shown in FIG. 3F).

Reference is now made to FIG. 3G, which schematically illustrates schematically illustrates a cone shaped smoking device, according to some embodiments. The cone shape of the smoking device may allow enhanced dispersing of the smoke.

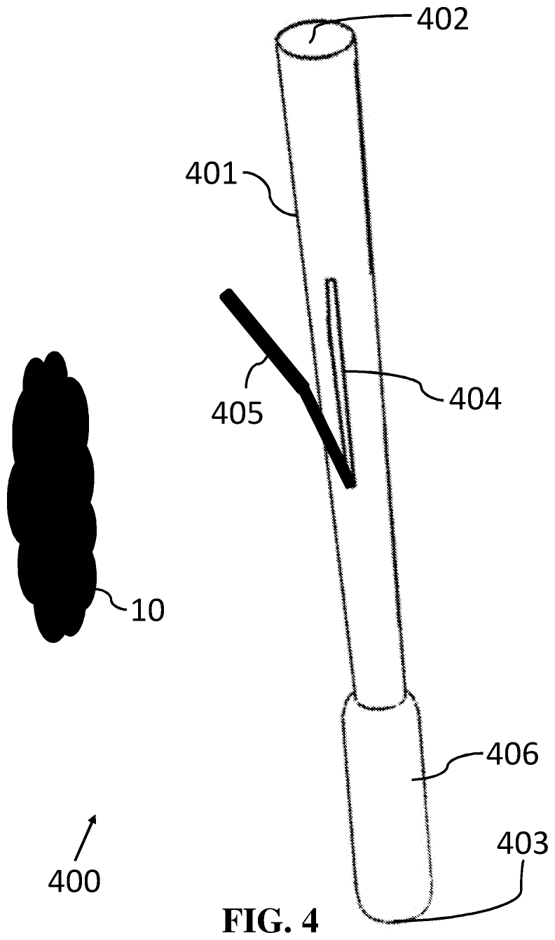

Reference is now made to FIG. 4, which schematically illustrates another smoking device 400, according to some embodiments. The smoking device 400 may include a hollow body 401, with a tube defining a combustion bore 402 and an inhaling bore 403 (e.g., similarly to the smoking device 100 as shown in FIGS. 1A, 1B, and 2).

The smoking device 400 may include one or more vents 404 to allow air access into the hollow body 401, and the smoking device 400 may further include a filter 406 adjacent to the inhaling bore 403. In some embodiments, the smoking device 400 may further include a flap 405 (similar to flap 105 as shown in FIGS. 1A, 1B, and 2) of a plurality of flaps, generally having an initial shape configured to cover each of the one or more vents 404. When a combustion front of the substance 10 recedes into the combustion bore 402, any flap 405 of the flaps 405 that is heated to a threshold temperature may bend away, thereby uncovering the vent 404 that it covers. In some embodiments, when cooled, that flap 405 may regain its initial shape so as to cover that vent 404.

In some embodiments, the one or more vents 404 may be sufficiently small such that there is no need for a heat activated flap to move between open vents and closed vents while maintaining a smoking experience similar to a rolled cigarette.

According to some embodiments, initially the flap 405 may be in a closed state such that the vent 104 is closed and the bore of the smoking device 400 may be filled with the substance 10 (e.g., tobacco). The user may light the substance 10 (e.g., with a lighter) via the combustion bore 402 so as to smoke the substance 10 via the inhaling bore 403. At the initial stage, the vent 404 may be closed in order to maintain the pressure created by smoking user's puff and accordingly smoke the substance 10 as in a rolled cigarette.

The lit substance 10 may create a combustion front that moves through the hollow body 401, from the combustion bore 402, past the filter 406, and towards the inhaling bore 403. During combustion, the heat from the lit substance 10 may increase the surrounding temperature and accordingly increase the temperature of the flap 405. As a result, the heat activated flap 405 may move (e.g., bend) to open the vent 404 and allow air access into the hollow body 401, and thereby to conduct a flow of air towards the lit substance 10 in order to maintain the combustion up to the next vent of the flap.

In some embodiments, when at least one flap 405 is moved (e.g., bended) to open the vent 404, combustion products, for instance, the results of burning the substance 10, may exit through the uncovered vent 404, thereby clearing space within the hollow body 401 for more air supply.

In some embodiments, at least one vent 404 may be open while other vents are closed. For example, when the combustion front reaches vent 404, and before the combustion front travels further in the hollow body 401, only vent 404 opens up. As the combustion front moves down the hollow body, more vents reached by the combustion front open up.

Once the combustion is complete, with all of the substance 10 smoked, all of the flaps 405 may be in an open state (e.g., bended) to open the vents 404 such that the one or more vents 404 is uncovered.

While certain features of the invention have been illustrated and described herein, many modifications, substitutions, changes, and equivalents may occur to those skilled in the art. It is, therefore, to be understood that the appended claims are intended to cover all such modifications and changes as fall within the invention.

Various embodiments have been presented. Each of these embodiments may of course include features from other embodiments presented, and embodiments not specifically described may include various features described herein.

1. A smoking device for smoking a substance, the smoking device comprising:
a hollow body, configured to hold the substance, wherein the hollow body comprises:
a tube defining a combustion bore having within it vents, each of the vents being covered by a flap of a plurality of flaps having an initial shape configured to cover that vent,
wherein, when a combustion front of substance recedes into the combustion bore, any flap of the flaps that is heated to a threshold temperature bends away, thereby uncovering the that vent it covers, and, when cooled, that flap regains its initial shape so as to cover that vent.

2. The smoking device of claim 1, wherein each flap is connected to the hollow body by a fixture.

3. The smoking device of claim 1, wherein the hollow body has a tubular shape.

4. The smoking device of claim 1, wherein the flap comprises a heat activated shape memory alloy.

5. The smoking device of claim 4, wherein the flap comprises Nitinol.

6. The smoking device of claim 1, wherein the flap comprises a heat activated material.

7. The smoking device of claim 6, wherein the flap comprises a bimetal.

8. The smoking device of claim 1, wherein area of each of the one or more vents is larger than the cross-section area of the combustion bore.

9. The smoking device of claim 1, further comprising an inhaling bore, configured to allow inhaling of smoke of the substance when burning.

10. The smoking device of claim 9, further comprising a filter adjacent to the inhaling bore.

11. The smoking device of claim 1, wherein the hollow body comprises low-thermal-expansion glass.

12. The smoking device of claim 11, wherein the glass comprises a glass portion that is at least partially transparent.

13. The smoking device of claim 1, wherein the threshold temperature is in the range of 100−900° C. degrees.

14. The smoking device of claim 1, wherein a shape of at least one vent is a perforated line.

15. The smoking device of claim 1, wherein a shape of at least one vent is at least one of a rectangle and an ellipse.

16. The smoking device of claim 15, wherein a shape of at least one flap is at least one of a rectangle and an ellipse.
